(19) United States
(12) Patent Application Publication
(10) Pub. No.: US 2007/0068636 A1
(43) Pub. Date: Mar. 29, 2007

(54) Suspension cord control mechanism for a window covering

(76) Inventors: Fu-Lai Yu, San Hsia Town (TW); Chin-Tien Huang, San Hsia Town (TW)

Correspondence Address: OLSON & HIERL, LTD., 20 NORTH WACKER DRIVE, 36TH FLOOR, CHICAGO, IL, 60606, US

(21) Appl. No.: 11/238,254

(22) Filed: Sep. 29, 2005

(51) Int. Cl. E06B 9/30

(52) U.S. Cl. 160/168.1 R

(57) ABSTRACT

A suspension cord control mechanism composed of an arresting mechanism and a biasing mechanism operable to move a light blocking element after the user has released a suspension cord. The biasing mechanism is loaded when the suspension cord is drawn by a user to lift the window covering. When the suspension cord is released, movement of the cord is stopped by the arresting mechanism and the biasing mechanism unloads to further move the light blocking element.

### TECHNICAL FIELD OF THE INVENTION

The present invention relates generally to a suspension cord control mechanism suitable for use with a window covering, and more particularly a top-down style window covering.

### BACKGROUND OF THE INVENTION

Window coverings including light blocking elements, such as honeycomb panels, have long been used to control or block the amount of light entering through a window and to provide privacy. Light control is obtained by controllable opening and closing of the light blocking element.

A common method for controlling the opening and closing of a light blocking element is to employ a weight actuated suspension cord lock system in a bottom-up configuration, so called because the covering is raised towards the head rail from the bottom up for retraction. A suspension cord is threaded through a cord lock in the head rail and connected to the bottom rail of the window covering at one end. To retract the light blocking element, a user pulls on the suspension cord, causing the bottom of the light blocking element to rise towards the head rail. The light blocking element is gathered according to a predetermined orderly pattern such as by folding, stacking or pleats as it is opened. The light blocking element can be fully or partially retracted. When the suspension cord is released, the cord lock in the head rail arrests the cord, holding the light blocking element in its state of deployment.

A top-down control mechanism found in window coverings operates in a similar fashion except that the position of the top portion of the light blocking element is adjusted by lowering and raising the top portion relative to a head rail. Top-down window coverings are preferred in certain situations, e.g. where it is desirable to let in light from the upper portion of the window while maintaining privacy and blocking outside light in the lower portion of the window. The use of both a bottom-up and top-down control mechanisms in a window covering provides maximum versatility.

A problem in the prior art results from arresting mechanisms utilized, such as cord locks. When a suspension cord is released, a certain amount of the suspension cord slips through the arresting mechanism on account of the weight of the light blocking element before the cord lock engages the suspension cord. Although this amount of slippage is relatively small, typically around ¼ inch to ½ inch, in a top-down window covering, this distance is sufficient to cause an undesirable gap between the light blocking element and the head rail. In addition to defeating the primary function of the window covering to block light, the unbridged gap is aesthetically unappealing.

Thus there is a need for a mechanism to reduce or eliminate the aforementioned problem by counteracting the drop in height between the release of the suspension cord and its arrest by the cord lock mechanism. Preferably, this mechanism substantially closes the gap normally left between the head rail and the top end of the light blocking element to block light.

### SUMMARY OF THE INVENTION

The present invention is related to a suspension cord control mechanism for a window covering. A suspension cord is attached on one end to a light blocking element such as a honeycomb panel, Roman shade panel, or Venetian blind slats. The suspension cord passes through a suspension cord control mechanism in the head rail, comprising a biasing mechanism and an arresting mechanism. The arresting mechanism can be a cord lock or cord arresting device such as those known in the art, which serves to arrest the movement of the suspension cord when a user is not pulling on the suspension cord.

In one preferred embodiment, the biasing mechanism includes a sliding plate. The plate is capable of movement along a portion of the length of the head rail and is attached to an end of the head rail by a spring. The suspension cord is guided around a roller on the sliding plate. When the suspension cord is drawn by a user, the cord is pulled through the suspension cord control mechanism, thereby raising the top portion of the light blocking element towards the head rail. The force on the suspension cord exerted by the user also causes the plate to slide away from the end of the head rail, thereby loading or tensioning the spring. When the cord is released, the arresting mechanism moves into engagement with the cord to secure its relative position. In addition, the potential energy stored in the spring is released as the spring contracts to its natural state, causing the plate to slide back and pull the suspension cord, further raise the light blocking element towards the head rail.

In an alternate preferred embodiment, the biasing mechanism comprises a pivoting bar with spools around which the suspension cord is engaged. In its natural position, the bar is perpendicular to the suspension cord. When the suspension cord is drawn, the bar pivots to a position substantially parallel to the length of the head rail thereby compressing a coil spring secured with the bar. As the user releases the suspension cord, the spring unloads and reverts to its natural position causing the pivoting bar to rotate to its position perpendicular to the suspension cord. The movement of the pivoting bar causes the suspension cord to retract such that the light blocking element is further urged towards the head rail.

In yet another preferred embodiment, the biasing mechanism includes two plates linked by a spring that slide transverse to one another other. The suspension cord is engaged around spools on each of the plates. When the suspension cord is drawn taut, the plates slide transversely to one another and compress the spring between them. When tension on the suspension cord is released and the cord is locked by the arresting mechanism, the spring reverts the plates to their natural rest state, pulling the suspension cord and urging the light blocking element towards the head rail.

### BRIEF DESCRIPTION OF THE DRAWINGS

In the drawings,

FIG. 1 is a front view of a preferred embodiment of the present suspension cord control mechanism with a top-down style light blocking element;

FIG. 2 is a top view of the suspension cord control mechanism of FIG. 1 in a rest state;

FIG. 3 is an exploded perspective view of the suspension cord control mechanism of FIG. 1;

FIG. 4 is a top view of the suspension cord control mechanism of FIG. 1 in a loaded state;

FIG. 5 is a front view of the suspension cord control mechanism of FIG. 1 in the loaded state;

FIG. 6 is a front view of an alternative embodiment of a suspension cord control mechanism with a top-down style light blocking element and head rail;

FIG. 7 is a top view of the suspension cord control mechanism of FIG. 6;

FIG. 8 is a cross sectional elevated side view of the suspension cord control mechanism of FIG. 6 in the rest state;

FIG. 9 is a perspective cutaway view of the suspension cord control mechanism of FIG. 6 in the rest state;

FIG. 10 is a perspective cutaway view of the suspension cord control mechanism of FIG. 6 in the loaded state;

FIG. 11 is a front view of an another alternative embodiment of a suspension cord control mechanism with a top-down style window covering and head rail;

FIG. 12 is a top view of the suspension cord control mechanism of FIG. 11;

FIG. 13 is a perspective cutaway view of the suspension cord control mechanism of FIG. 11;

FIG. 14 is a perspective cutaway view of the suspension cord control mechanism of FIG. 11 in the loaded position; and

FIG. 15 is a perspective cutaway view of the suspension cord control mechanism of FIG. 11 in the rest position.

### DETAILED DESCRIPTION OF THE PREFERRED EMBODIMENTS

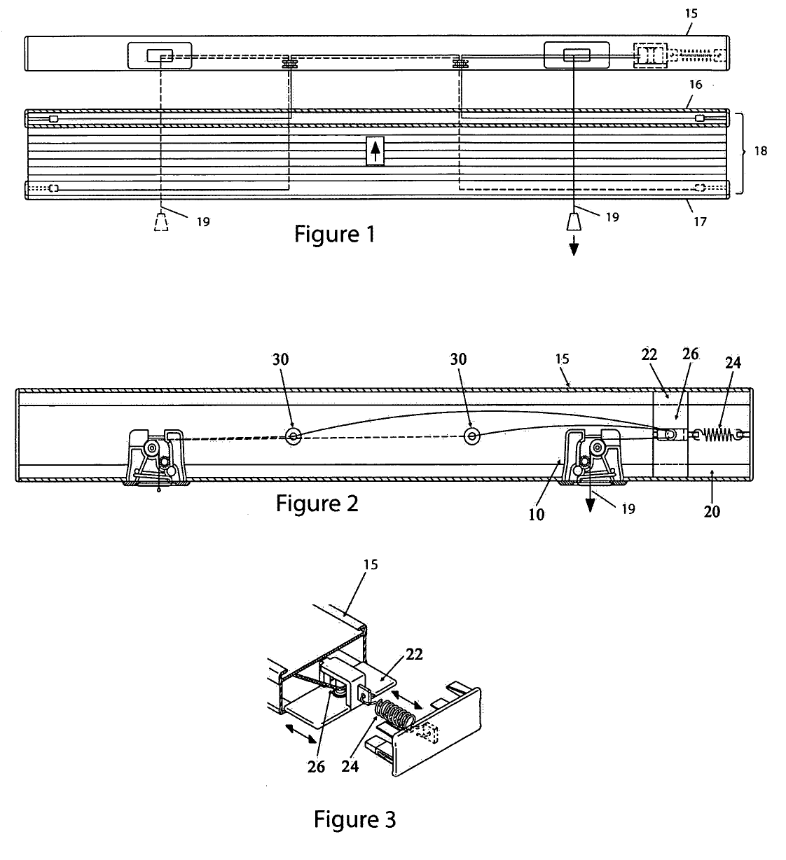

Referring now to the drawings, FIGS. 1 and 2 depict a top down style window covering comprising a head rail 15 and a light blocking element 18. The light blocking element 18 may include one or more closure panels movable to allow and block light passage, and which may take the form of a honeycomb panel, a Roman style shade, a Venetian blind, or the like. The light blocking element 18 also includes a top portion, such as top rail 16 and a bottom portion, such as bottom rail 17. It should be recognized that while the depicted embodiments show a top rail 16 and bottom rail 17, they are not strictly necessary and can simply be the top and bottom portions of the light blocking device. A suspension cord 19 for controlling the deployment of light blocking element 18 is connected at one end to the top rail 16 and passes through openings 30 in the head rail 15. The suspension cord 19 also operatively engages the suspension cord control mechanism. The suspension cord control mechanism comprises of a biasing mechanism 20 and arresting mechanism 10.

The arresting mechanism 10 is configured to engage the suspension cord 19 such that the position of the suspension cord 19 is maintained and may take the form of a window cord lock mechanism, clutch or other device for this purpose known in the art. When a user pulls on the suspension cord, the arresting mechanism disengages from the suspension cord 19 such that the cord 19 is permitted to slide freely therethrough. When the user releases the cord 19, the arresting mechanism 10 again engages the cord 19.

In the embodiment depicted in FIGS. 2 and 3, biasing mechanism 20 comprises a sliding plate 22, spring 24 and rotary roller 26. Sliding plate 22 is slidable along at least a portion of the length of the head rail 15. Rotary roller 26 is fixably connected to sliding plate 22. The suspension cord 19 is operatively engaged with rotary roller 26, although it is understood that roller 26 may be a pin or other apparatus connected or integral to sliding plate 22 that permits the suspension cord 19 to move somewhat freely. One end of spring 24 is connected to sliding plate 22 and another end of spring 24 is connected to head rail 15. Spring 24 can be replaced with other elastic means capable of storing potential energy under tension or compression.

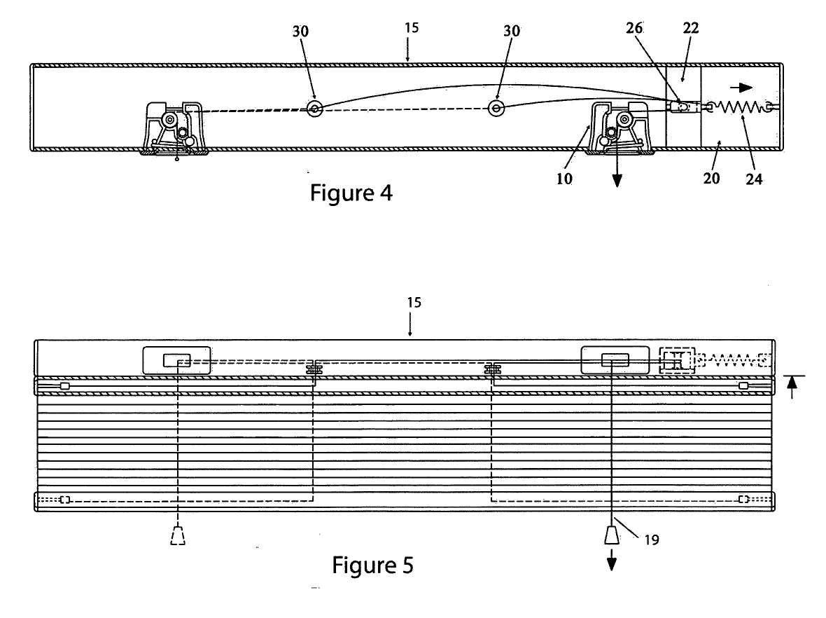

FIGS. 4 and 5 show the operation of the biasing mechanism 20. When a downward force is applied to the free end of suspension cord 19 by a user, the cord 19 raises top rail 16 of light blocking element 18 towards the head rail 15. Since cord 19 is operatively engaged with roller 26 on sliding plate 22, the action of pulling cord 19 by the user (shown by the downward arrow in FIGS. 4 and 5) also causes sliding plate 22 to move laterally down the length of and away from the end of head rail 15. In doing so, the movement of slidable plate 22 relative to the end of head rail 15 tensions spring 24 from its rest state. Spring 24 should be selected to be of an appropriate stiffness so that the spring 24 does not prevent the motion of sliding plate 22 but stiff enough that the spring 24 can overcome the weight of light blocking element 18.

When the suspension cord 19 is released by the user, the weight of light covering element 18 will cause the suspension cord 19 to fall and slide in a reverse direction. This action is prevented by arresting mechanism 10, which locks the cord 19 in place and prevents movement. As the arresting mechanism 10 moves from an open position where the cord 19 is free to move to an engaged position where the position of cord 19 is maintained, a small amount of cord 19 slides such that the top rail 16 moves away from the head rail 15. When cord 19 is arrested such that there is no longer an force tensioning spring 24, the spring 24 returns to its relaxed state and returns sliding plate 22 to its initial starting position. Since the length of cord 19 between the arresting mechanism 10 and top portion 16 of the light blocking element 18 is fixed once the cord 19 is arrested by the arresting mechanism 10, the movement of sliding plate 22 towards the end of the head rail 15 has the effect of urging top portion 16 of the light blocking element towards the head rail 15. This movement counteracts and compensates for the downward movement of the light covering element 18 under its own weight when the cord 19 was initially released by the user prior to being engaged by arresting mechanism 10.

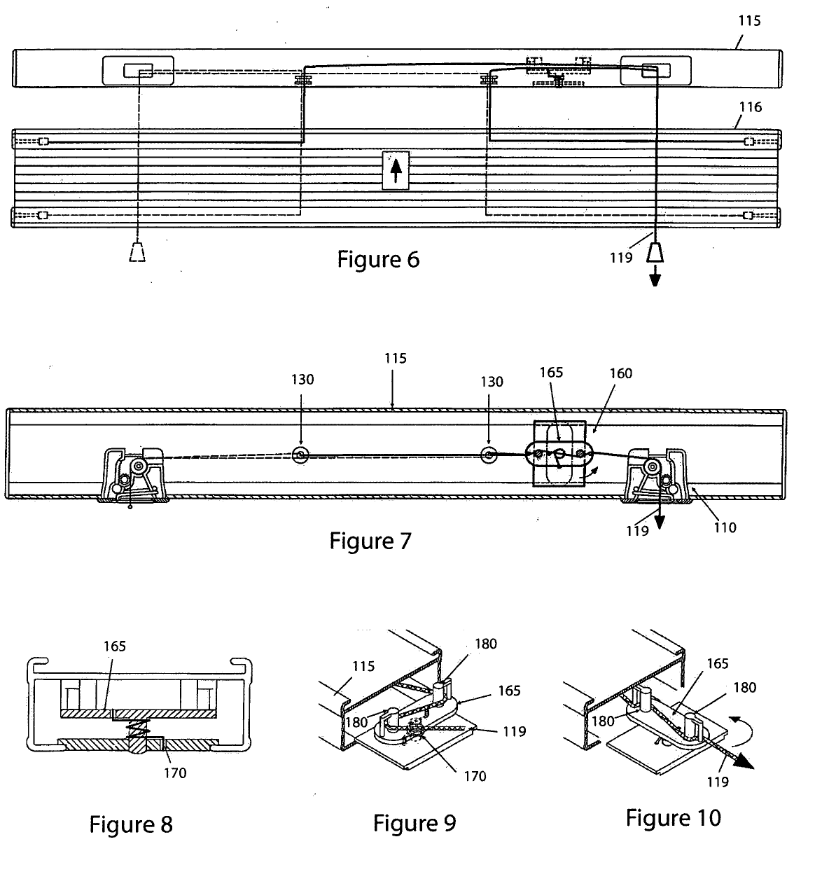

It should be noted that the biasing mechanism of the suspension cord control mechanism can take any number of variant forms. One such alternative preferred embodiment is shown in FIGS. 6-10. Cord 119 is connected to the top portion 116 of the light blocking element through openings 130 and is operatively engaged with biasing mechanism 160 and arresting mechanism 110. In this embodiment, the biasing mechanism 160 comprises a rotary plate 165 pivotably mounted to the head rail 115. One end of torque spring 170 is fixably connected to rotary plate 165 while the other end of spring 170 is fixably connected to the head rail 115. Fixably mounted or integral to the rotary plate 165 are at least two projections 180 around which the cord 119 is engaged.

In its rest state, torque spring 170 positions the rotary plate 165 transversely across the width of head rail 115. In operation, when cord 119 is pulled, the force on cord 119 is in a direction substantially parallel to the length of the head rail 115. This force causes the rotary plate 165 to rotate from its rest state into a position substantially parallel to the length of the head rail 115. The rotation of rotary plate 165 deforms and loads torque spring 170. When the cord 119 is released and arrested by arresting mechanism 110, the loaded spring 170 rotates the plate 165 back to its rest state, pulling on the cord 119 and raising top portion 116 closer towards head rail 115.

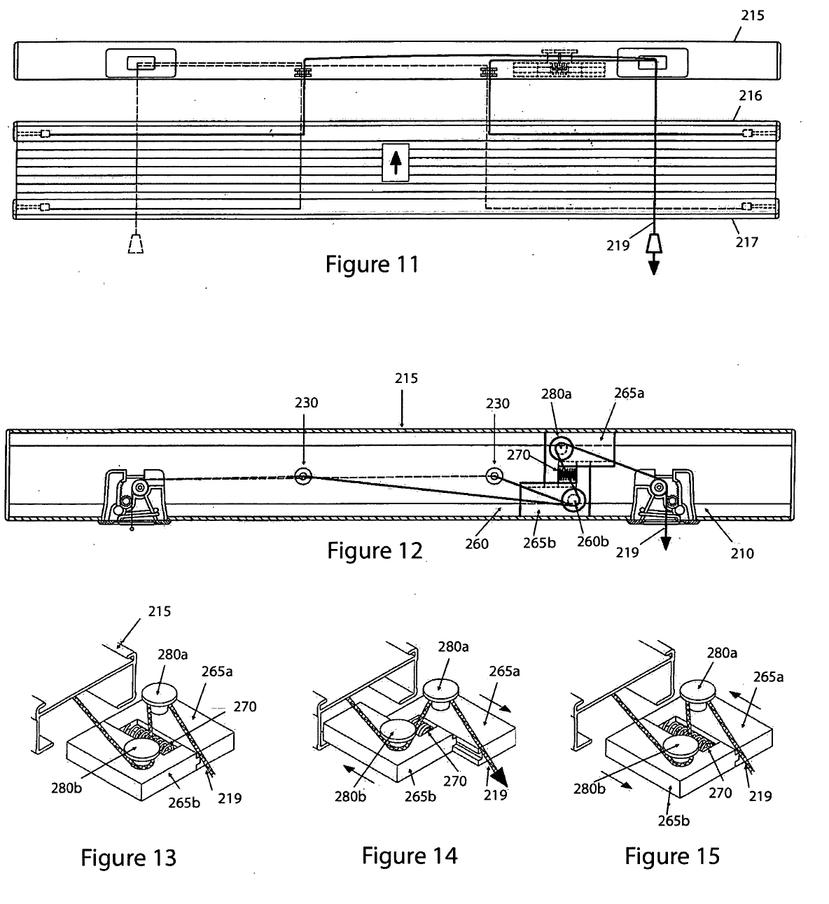

Yet another preferred embodiment of a biasing mechanism sutiable for the present suspension cord control mechanism is shown in FIGS. 11-15. Suspension cord 219 is connected to the top rail 216 of the light blocking element, which may also have a weighted bottom rail 217 so that the light blocking element hangs freely. The cord 219 is threaded through head rail 215 via openings 230 and is operatively engaged with the biasing mechanism 260 and arresting mechanism 210.

As more clearly shown in FIG. 13, the biasing mechanism 260 located in head rail 215 includes two sliding plates 265a and 265b. Mounted on each sliding plate 265a and 265b are projections 280a and 280b, which may be fixably mounted or integral to the sliding plate. In the rest state, projections 280a and 280b are situated offset relative to each other across the width of the head rail 215. The plates 265a and 265b are slidable in a lateral direction relative to each other and longitudinally down a portion of the length of head rail 215. Plates 265a and 265b are further connected by a spring 270 interactively engaged between them.

In operation, when suspension cord 219 is pulled, the cord 219 causes the top rail 216 to move in the direction of head rail 215. Simultaneously, the component of the force parallel to the longitudinal length of the head rail 115 pulls the offset projections 280a and 280b. This force causes projection 280a and plate 265a to slide laterally relative to projection 280b and plate 265b, loading spring 270 by compression.

When the cord 219 is released, the light blocking element falls of its own weight a short distance before its movement is arrested when the arresting mechanism 210 arrests the movement of suspension cord 219. When the cord 219 has been arrested, loaded spring 270 unloads to drive plates 265a and 265b back into their original position. This movement results in lengthening the distance of cord 219 between projections 280a and 280b and-pulls on the cord 219, lifting the top portion 216 towards head rail 215.

While the various descriptions of the present invention are described above, it should be understood that various features can be used singly or in combination thereof. Therefore, this invention is not to be limited to the specific preferred embodiments depicted herein. Further, it should be understood that variations and modifications within the spirit and scope of the invention may occur to those skilled in the art to which the invention pertains. Accordingly, all expedient modifications readily attainable by one versed in the art from the disclosure set forth herein that are within the scope and spirit of the present invention are to be included as further embodiments of the present invention. The scope of the present invention is accordingly set forth in the appended claims.

What is claimed is:

1. A cord control mechanism suitable for use with a window covering including at least a head rail and a light blocking element connected to the head rail via a suspension cord, the cord control mechanism comprising:
a cord arresting mechanism, engageable with the suspension cord to stop a sliding motion of the suspension cord; and
a biasing mechanism operable to tension the suspension cord so as to draw the light blocking element towards the head rail.

2. The cord control mechanism of claim 1, wherein the biasing mechanism includes a movable piece in contact with the suspension cord, and a spring connecting the movable piece with the head rail.

3. The cord control mechanism of claim 2, wherein the movable piece I sin sliding contact with the suspension cord.

4. The cord control mechanism of claim 2, wherein the movable piece is configured to effect a movement to load the spring under application of a pulling force on the suspension cord.

5. The cord control mechanism of claim 2, wherein the movable piece is configured to effect a movement to tension the suspension cord under action of a resilient force released from the spring when the arresting mechanism engages with the suspension cord.

6. The cord control mechanism of claim 2, wherein the movable piece is configured to perform rotating movements.

7. The cord control mechanism of claim 2, wherein the movable piece is configured to perform sliding movements.

8. The cord control mechanism of claim 1, further being mounted in the head rail.

9. The cord control mechanism of claim 1, wherein the biasing mechanism urges the light blocking element to be substantially flush with the head rail.

10. A window covering comprising:
a head rail;
a light blocking element connected with the head rail via a suspension cord; and
a cord control mechanism comprising a cord arresting mechanism, engageable with the suspension cord to stop a sliding motion of the suspension cord; and a biasing mechanism operable to tension the suspension cord so as to draw the light blocking element towards the head rail.

11. The window covering of claim 10, wherein the biasing mechanism includes a movable piece in contact with the suspension cord, and a spring connecting the movable piece with the head rail.

12. The window covering of claim 11, wherein the movable piece is in sliding contact with the suspension cord.

13. The window covering of claim 11, wherein the movable piece is configured to effect a movement to load the spring under application of a pulling force on the suspension cord.

14. The window covering of claim 11, wherein the movable piece is configured to effect a movement to tension the suspension cord under action of a resilient force released from the spring when the arresting mechanism engages with the suspension cord.

15. The window covering of claim 11, wherein the movable piece is configured to perform rotating movements.

16. The window covering of claim 11, wherein the movable piece is configured to perform sliding movements.

17. The window covering of claim 10, wherein the cord control mechanism is mounted in the head rail.

18. The window covering of claim 10, wherein the biasing mechanism urges the light blocking element to be substantially flush with the head rail.

19. The window covering of claim 10, wherein the light blocking element includes at least one closure panel and an uppermost rail.

20. The window covering of claim 19, wherein the closure panel is movable between an open position to allow light passage and a closed position to block light passage.
